(19) United States
(12) Patent Application Publication
(10) Pub. No.: US 2025/0157728 A1
(43) Pub. Date: May 15, 2025

(54) METHOD FOR PRODUCING A MULTILAYERED MAGNET

(71) Applicant: Siemens Aktiengesellschaft, 80333 München (DE)

(72) Inventors: REINER SEUFERT, Salz (DE); ROLF VOLLMER, Gersfeld (DE)

(73) Assignee: Siemens Aktiengesellschaft, 80333 München (DE)

(21) Appl. No.: 18/833,668

(22) PCT Filed: Jan. 31, 2023
(86) PCT No.: PCT/EP2023/052298

§ 371 Date: Jul. 26, 2024

(30) Foreign Application Priority Data
Feb. 23, 2022 (EP) 22158256.2

(51) Int. Cl. H01F 41/02; B29C 45/16; B29K 105/16; B29K 505/12; B32B 27/20; H01F 7/02

(52) U.S. Cl. CPC H01F 41/0266; H01F 7/0205; B29C 45/1671; B29K 2105/16; B29K 2505/12; B29K 2995/0008; B32B 27/20; B32B 2264/1056; B32B 2264/107; B32B 2307/208

(57) ABSTRACT

In a method for producing a multilayered magnet with a plurality of first layers and a plurality of second insulating layers which follow one another alternately, material having magnetic material and a binder is applied by injection molding to a base plate to form a first layer of a green body at a thickness of at least 1.5 mm and at most 4 mm. Further material is applied by injection molding to form a second insulating layer of the green body adjacent to the first layer at a thickness of at least 0.01 mm and at most 0.1 mm, with the further material being an electrically poorly conducting material with an electrical conductivity which is between 1·10⁻⁸ and 1·10⁻¹⁴ S/m; and/or the second insulating layer is formed by oxidizing a surface of the first layer through application of an oxidizing agent; and/or by applying the binder by injection molding.

Permanently excited synchronous machines have a plurality of permanent magnets. However, eddy currents are induced in these magnets by changes in the magnetic field, and these currents are accompanied by losses.

In order to reduce heat losses due to current, magnets are divided, for example sawn apart, into electrically insulated segments. These segments are then glued together again.

However, this is laborious and expensive.

The invention is based on the object of improving the production of magnets which have electrically insulated segments.

The object is achieved by claim 1, that is to say a method for producing a multilayered magnet, wherein a first layer of a green body is formed by applying material by means of injection molding to a base plate, wherein the material has magnetic material and a binder, wherein a second insulating layer of the green body is formed by applying further material by means of injection molding to and/or adjacent to the first layer, wherein the further material is an electrically poorly conducting material with an electrical conductivity which is between 1·10⁻⁸ and 1·10⁻¹⁴ S/m, and/or is formed by oxidizing a surface of the first layer and/or is formed by applying the binder by means of injection molding.

The second insulating layer of the green body is formed by applying further material by means of injection molding to (with “to” in this connection preferably describing contact from above) and/or adjacent to (with “adjacent” in this connection describing that the two layers have a shared boundary) the first layer.

The base plate advantageously serves as an aid during production and is preferably removed again.

Advantageously, the material for the first layer is in the form of a granular material, for example powder. This is advantageously melted and sprayed on.

Advantageously, the further material for the second layer is in the form of a granular material, for example powder. This is advantageously melted and sprayed on.

The material for the first layer has magnetic material. NdFeB powder and/or SmCo powder is particularly advantageous in this connection.

Recycling material in the form of ground old magnets can be used for this purpose, and this requires only an input of energy and results in only low CO2 emissions. Other materials are also conceivable.

Further, the material contains a binder, for example plastic binder.

Preferably, a plurality of layers is alternately formed. That is to say, preferably the first layer (can also be referred to as the magnetic layer) is formed and the second layer (can also be called the insulation layer) is then preferably formed, a magnetic layer is then formed again and subsequently an insulation layer is formed again. This is advantageously repeated until a desired size of the magnet is achieved. Preferably, a magnetic layer is formed as the final layer.

An embodiment according to which the first layer is formed by means of powder injection molding is advantageous.

Powder injection molding is also known by the term “MIM method” (Metal Injection Molding). Powder injection molding advantageously has the following, in particular successive, process steps: feedstock production, injection molding, debinding and sintering. The permanent magnet produced in this way can be post-treated.

Feedstock is advantageously produced in this connection by mixing a metal powder, in particular magnetic powder, with a plastics material, preferably a thermoplastic. The mixture can be referred to as the feedstock.

The feedstock preferably also contains other substances, by way of example the binders already mentioned, for example at least one organic binder.

Heating the feedstock is advantageous.

An embodiment according to which the second insulating layer is formed by means of multi-component injection molding, in particular 2K injection molding, is advantageous.

Advantageously, at least two components are melted and applied, preferably under pressure. For example, a ceramic or yttrium oxide with organic binders, such as terpineols, can be used.

An embodiment according to which the surface of the first layer is oxidized by applying an oxidizing agent, for example an oxidizing agent having sodium peroxide and/or iron oxide, is advantageous. Other oxidizing agents are also conceivable.

As an alternative or in addition to applying the second material, the oxidizing agent which results in oxidation is advantageously applied.

Advantageously, the surface is only affected during a sintering procedure at a later instant.

If, for example, a first layer, which has, for example, NdFeB, is treated with iron oxide, the iron oxide attaches to the first layer and/or neodymium oxide particles form on the surface of the first layer. An insulating layer can thus be produced.

An embodiment according to which the further material is ceramic, for example aluminum oxide, is advantageous.

Particularly preferred are oxidic ceramics. Advantageously, the oxides are lanthanides, for example the inexpensive cerium oxide.

Other materials, which guarantee the insulation of two magnetic layers from each other, are also conceivable.

An embodiment according to which the binder is expelled from the green body to obtain a brown body, in particular by means of debinding, is advantageous.

In the case of debinding, the binder is removed from the green body with thermic and/or catalytic debinding.

Preferably, the green body, i.e. the injection molded part, is placed in a debinding furnace. Reference can be made to a brown body at the end of this procedure. Thermic debinding advantageously occurs in the debinding furnace. The binder advantageously breaks down in this way.

Alternatively or in addition, the binder can be expelled by means of microwave sintering.

Advantageously, sintering then takes place.

An embodiment according to which the brown body is compressed and hardened by means of sintering is advantageous.

The object is also achieved by a magnet, having a plurality of layers, at least one first layer and one second insulating layer, produced according to the described method.

An embodiment of the magnet according to which the first layer is at least 1.5 mm and at most 4 mm thick is advantageous.

A magnetic layer thickness is advantageously between 1.5 mm and 4 mm. At least 3 mm and at most 3.5 mm are particularly advantageous for the magnetic layer thickness. The magnetic properties decline sharply below 3 mm. A compromise between optimally low eddy current losses in the magnet and all of the magnetic properties is advantageously accepted in this connection.

It is possible to produce very thin magnetic layers, also called magnetic segment layers, by way of the method. The described thickness has the following advantage: only very small eddy currents are produced in the magnet during operation.

The described magnetic layers which can be produced by means of the method can be much thinner than can be produced by means of conventional methods.

Preferably, the first layer is thicker than the second insulating layer.

An embodiment according to which the second insulating layer is at least 0.01 mm and at most 0.1 mm thick is particularly advantageous.

As a result, only a small magnetically active volume is replaced by a magnetically inactive volume.

The object is achieved, moreover, by a dynamoelectric machine, in particular a permanently excited synchronous machine, having at least one magnet of this kind.

Preferably, the machine has a plurality of magnets of this kind.

It is also possible to segment complex magnet geometries, for example arc magnets, due to the segmenting possible by way of the method. By way of example, magnets with thin edges (for example loaf magnets or sunken-edge magnets) can be easily produced.

The method is less laborious than the previous method.

The described magnet can be used in the radio-frequency range, for example high-speed processing motors, EV motors and in motors and generators in aircraft.

The invention will be described and explained in more detail below on the basis of the exemplary embodiments illustrated in the figures. In the drawings:

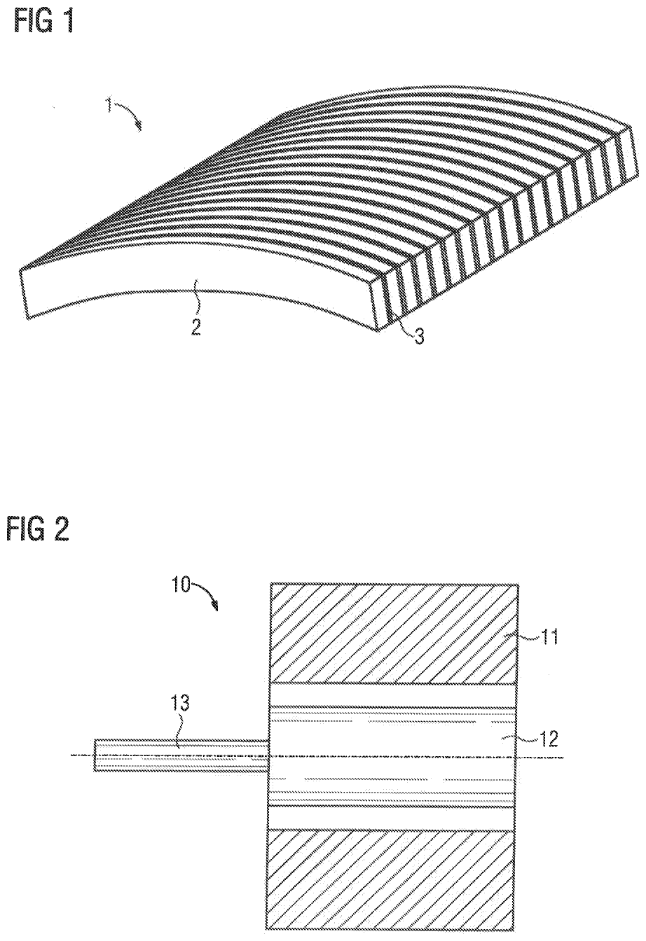

FIG. 1 shows a magnet,

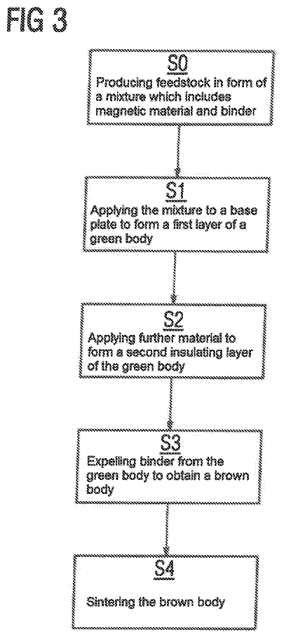

FIG. 2 shows a machine,

FIG. 3 shows a method for production.

FIG. 1 shows a magnet 1.

In the figure, the magnet has a plurality of layers. A first layer 2 and a second insulating layer 3 are shown. The first layer 2 is advantageously a magnetic layer.

Advantageously, the magnet has a plurality of magnetic layers, with an insulating layer 3 being embodied between two magnetic layers.

FIG. 2 shows a dynamoelectric rotatory machine 10.

This has a stator 11, a rotor 12 and a shaft 13.

FIG. 3 shows the method for production.

Feedstock is produced in a method step S0. The feedstock is advantageously produced by mixing the magnetic powder with a binder. Further substances can be included. Heating the feedstock is advantageous.

In a method step S1, the material is applied to a base plate to form a first layer by means of injection molding, in particular by means of metal injection molding. A magnetic layer is thus formed.

In a method step S2, a second insulating layer (also called an insulation layer) is formed by applying further material by means of injection molding, in particular by means of 2K injection molding, to and/or adjacent to the first layer, with the material being an electrically poorly conducting material.

Alternatively or in addition, the second insulating layer can be formed by oxidizing a surface of the first layer.

Alternatively or in addition, the second insulating layer can be formed by applying the binder by means of injection molding.

Therefore, only the described binder or a material mixture, which predominantly has the binder, can be applied. Advantageously, a porous metal-connecting layer, which possesses low electrical conductivity, is produced in the case of a debinding process (see method step S3) and a, preferably subsequent, sintering process. A high mechanical strength can be achieved by an advantageous subsequent infiltration of adhesive.

Method steps S1 and S2 are advantageously repeated until a desired size of the magnet is achieved. Preferably, a magnetic layer is formed as the final layer.

Preferably, the magnet has a plurality of magnetic layers and a plurality of insulation layers which follow one another alternately.

Debinding, i.e. expelling of binders, takes place in a method step S3.

Debinding preferably takes place at a temperature of 200° C. to 400° C.

Sintering takes place in a method step S4.

Sintering preferably takes place at a temperature of 900° C. to 1,100° C.

The magnet 1 is thus effectively solidified.

The magnet 1 illustrated in FIG. 1 can be produced by way of the described method.

In other words, the invention can also be explained as follows: the magnets are advantageously produced by means of the MIM injection molding method, advantageously anisotropically. A magnetic feedstock advantageously has recycled NdFeB powder and a binder, in particular plastic binder. The binder is advantageously fully removed from the magnetic body in the thermic debinding process. Preferably, a plurality of layers is injected. Advantageously, insulating layers or insulation layers are produced between the layers. The insulating layers are preferably produced by 2K injection molding, for example by injecting a thin layer, which is made substantially from electrically poorly conductive or also non-conductive material or has a material of this kind, onto the first magnetic layer. Preferably, magnetic and insulation layers are alternately injected. An insulation material or a material for the insulation layer preferably has a ceramic, for example aluminum oxide. Alternatively or in addition, the insulating layer is produced by superficially oxidizing the surface of the magnetic layer. Alternatively or in addition, only or predominantly binder is injected as the intermediate step. Advantageously, a porous metal-connecting layer, which possesses low electrical conductivity, is produced in the debinding process and advantageously the subsequent sintering process. A high mechanical strength can be achieved by subsequent infiltration of adhesive.

The method for producing a multilayered magnet 1 results in a first layer 2 of a green body being formed by applying material by means of injection molding to a base plate, wherein the material has magnetic material, for example NdFeB powder and/or SmCo powder, and a binder, for example plastic binder, wherein a second insulating layer 3 of the green body is formed by applying further material by means of injection molding to and/or adjacent to the first layer, wherein the further material is an electrically poorly conducting material with an electrical conductivity which is between 1·10⁻⁸ and 1·10⁻¹⁴ S/M and/or is formed by oxidizing a surface of the first layer and/or is formed by applying the binder by means of injection molding.

1.-12. (canceled)

13. A method for producing a multilayered magnet with a plurality of first layers and a plurality of second insulating layers which follow one another alternately, the method comprising:
applying material having magnetic material and a binder by injection molding to a base plate to form a first layer of a green body at a thickness of at least 1.5 mm and at most 4 mm;
applying further material by injection molding to form a second insulating layer of the green body adjacent to the first layer at a thickness of at least 0.01 mm and at most 0.1 mm, with the further material being an electrically poorly conducting material with an electrical conductivity which is between 1·10⁻⁸ and 1·10⁻¹⁴ S/m; and/or forming the second insulating layer by oxidizing a surface of the first layer through application of an oxidizing agent; and/or forming the second insulating layer by applying the binder by injection molding.

14. The method of claim 13, wherein the magnetic material is NdFeB powder and/or SmCo powder.

15. The method of claim 13, wherein the binder is a plastic binder.

16. The method of claim 13, wherein the second insulating layer is applied by multi-component injection molding.

17. The method of claim 16, wherein the multi-component injection molding is 2K injection molding.

18. The method of claim 13, wherein the oxidizing agent includes sodium peroxide and/or iron oxide.

19. The method of claim 13, wherein the first layer is formed by powder injection molding.

20. The method of claim 13, wherein the further material is ceramic.

21. The method of claim 20, wherein the ceramic is aluminum oxide.

22. The method of claim 13, further comprising expelling the binder from the green body to obtain a brown body.

23. The method of claim 22, further comprising compressing and hardening the brown body by sintering.

23. A magnet comprising:
a plurality of first layers having a thickness of at least 1.5 mm and at most 4 mm; and
a plurality of second insulating layers having a thickness of at least 0.01 mm and at most 0.1 mm, with the plurality of first layers and the plurality of second insulating layers following one another alternately,
wherein the first layer of a green body is formed by applying material by injection molding to a base plate, with the material having magnetic material and a binder, and
wherein the second insulating layer of the green body is formed by applying further material by injection molding adjacent to the first layer, with the further material being an electrically poorly conducting material with an electrical conductivity which is between 1·10⁻⁸ and 1·10⁻¹⁴ S/m and/or wherein the second insulating layer is formed by oxidizing a surface of the first layer, with the surface of the first layer being oxidized by applying an oxidizing agent and/or wherein the second insulating layer is formed by applying the binder by injection molding.

24. The magnet of claim 23, wherein the magnetic material is NdFeB powder and/or SmCo powder.

25. The magnet of claim 23, wherein the binder is a plastic binder.

26. The magnet of claim 23, wherein the oxidizing agent includes sodium peroxide and/or iron oxide.

27. The magnet of claim 23, wherein the further material is ceramic.

28. The magnet of claim 27, wherein the ceramic is aluminum oxide.

29. The magnet of claim 23, wherein the first layer is thicker than the second insulating layer.

30. A dynamoelectric machine comprising a magnet, said magnet comprising a plurality of first layers having a thickness of at least 1.5 mm and at most 4 mm, and a plurality of second insulating layers having a thickness of at least 0.01 mm and at most 0.1 mm, with the plurality of first layers and the plurality of second insulating layers following one another alternately, wherein the first layer of a green body is formed by applying material by injection molding to a base plate, with the material having magnetic material and a binder, and wherein the second insulating layer of the green body is formed by applying further material by injection molding adjacent to the first layer, with the further material being an electrically poorly conducting material with an electrical conductivity which is between 1·10⁻⁸ and 1·10⁻¹⁴ S/m and/or wherein the second insulating layer is formed by oxidizing a surface of the first layer, with the surface of the first layer being oxidized by applying an oxidizing agent and/or wherein the second insulating layer is formed by applying the binder by injection molding.

31. The dynamoelectric machine of claim 30, constructed in a form of a permanently excited synchronous machine.
